(19) United States
(12) Patent Application Publication
(10) Pub. No.: US 2012/0189064 A1
(43) Pub. Date: Jul. 26, 2012

(54) ADAPTIVE LOOP FILTERING USING MULTIPLE FILTER SHAPES

(75) Inventors: Faouzi KOSSENTINI, North Vancouver (CA); Hassen GUERMAZI, Sfax (TN); Nader MAHDI, Sfax (TN); Mohamed Ali Ben AYED, Sfax (TN); Michael HOROWITZ, Austin, TX (US)

(73) Assignee: EBRISK VIDEO INC., North Vancouver (CA)

(21) Appl. No.: 13/350,373

(22) Filed: Jan. 13, 2012

Related U.S. Application Data
(60) Provisional application No. 61/432,634, filed on Jan. 14, 2011.
(60) Provisional application No. 61/432,643, filed on Jan. 14, 2011.
(60) Provisional application No. 61/448,487, filed on Mar. 2, 2011.
(60) Provisional application No. 61/499,088, filed on Jun. 20, 2011.

(51) Int. Cl. H04N 7/26

(52) U.S. Cl. 375/240.25; 375/240.29; 375/E07.027; 375/E07.193

(57) ABSTRACT

Disclosed are adaptive loop filtering techniques in the context of video encoding and/or decoding. For each video unit, the encoder can select a filter shape, and can place into the bitstream information that identifies the filter shape. At least one filter whose shape is the selected filter shape is used to loop filter at least one sample. At the decoder, a filter shape is obtained by decoding information that identifies the filter shape. At least one filter whose shape is the obtained filter shape is used to loop filter at least one reconstructed sample. Different filter shapes are also disclosed.

### CROSS-REFERENCE TO RELATED APPLICATIONS

This application claims priority from each of U.S. Provisional Patent Application Ser. No. 61/432,634, filed Jan. 14, 2011, entitled “ADAPTIVE LOOP FILTERING USING TABLES OF FILTER SETS FOR VIDEO CODING”, U.S. Provisional Patent Application Ser. No. 61/432,643, filed Jan. 14, 2011, entitled “ADAPTIVE LOOP FILTERING USING MULTIPLE FILTER SHAPES”, U.S. Provisional Patent Application Ser. No. 61/448,487, filed Mar. 2, 2011, entitled “ADAPTIVE LOOP FILTERING USING MULTIPLE FILTER SHAPES”, and U.S. Provisional Patent Application Ser. No. 61/499,088, filed Jun. 20, 2011, entitled “SLICE- AND CODING UNIT-BASED ADAPTIVE LOOP FILTERING OF CHROMINANCE SAMPLES”; the entire contents of all four applications is herein incorporated by reference.

### FIELD

Embodiments of the invention relate to video compression, and more specifically, to adaptive loop filtering techniques using a plurality of filter shapes in the context of video encoding and/or decoding.

### BACKGROUND

Digital video capabilities can be incorporated into a wide range of devices, including digital televisions, digital direct broadcast systems, wireless broadcast systems, personal digital assistants (PDAs), laptop or desktop computers, video cameras, digital recording devices, video gaming devices, video game consoles, cellular or satellite radio telephones, and the like. Digital video devices may implement video compression techniques, such as those described in standards like MPEG-2, MPEG-4, both available from the International Organization for Standardization (ISO), 1, ch. De la Voie-Creuse, Case postale 56, CH 1211 Geneva 20, Switzerland, or www.iso.org, or ITU-T H.264/MPEG-4 Part 10 Advanced Video Coding (“AVC”), available from the International Telecommunication Union (“ITU”), Place de Nations, CH-1211 Geneva 20, Switzerland, or www.itu.int, each of which is incorporated herein in its entirety, or according to other standard or non-standard specifications, to encode and/or decode digital video information efficiently. Still other compression techniques may be developed in the future or are presently under development. For example, a new video compression standard known as HEVC/H.265 is under development in the JCT-VC committee. One HEVC/H.265 working draft is set out in “Wiegand et. al., “WD3: Working Draft 3 of High-Efficiency Video Coding, JCT-VC-E603”, March 2011, henceforth referred to as “WD3” and incorporated herein by reference in its entirety.

A video encoder can receive uncoded video information for processing in any suitable format, which may be a digital format conforming to ITU-R BT 601 (available from the International Telecommunications Union, Place de Nations, 1211 Geneva 20, Switzerland, www.itu.int, and which is incorporated herein by reference in its entirety) or in some other digital format. The uncoded video may be organized both spatially into pixel values arranged in one or more two-dimensional matrices, as well as temporally in a series of uncoded pictures, with each uncoded picture comprising one or more of the above-mentioned one or more two-dimensional matrices of pixel values. Further, each pixel may comprise a number of separate components used, for example, to represent color in digital formats. One common format for uncoded video that is input to a video encoder has, for each group of four pixels, four luminance samples which contain information regarding the brightness/lightness or darkness of the pixels, and two chrominance samples which contain color information (e.g., YCrCb 4:2:0).

One function of video encoders is to translate or otherwise process uncoded pictures into a bitstream, packet stream, NAL unit stream, or other suitable transmission or storage format (all referred to as “bitstream” henceforth), with goals such as reducing the amount of redundancy encoded into the bitstream to thereby decreasing (on average) the number of bits per coded picture, increasing the resilience of the bitstream to suppress bit errors or packet erasures that may occur during transmission (collectively known as “error resilience”), or other application-specific goals. Embodiments of the present invention provide for at least one of the removal or reduction of redundancy, a procedure also known as compression.

One function of video decoders is to receive as its input a coded video in the form of a bitstream that may have been produced by a video encoder conforming to the same video compression standard. The video decoder then translates or otherwise processes the received coded bitstream into uncoded video information that may be displayed, stored, or otherwise handled.

Both video encoders and video decoders may be implemented using hardware and/or software options, including combinations of both hardware and software. Implementations of either or both may include the use of programmable hardware components such as general purpose central processing units (CPUs), such as found in personal computers (PCs), embedded processors, graphic card processors, digital signal processors (DSPs), field-programmable gate arrays (FPGAs), or others. To implement at least parts of the video encoding or decoding, instructions may be needed, and those instructions may be stored and distributed using a computer readable media. Computer readable media choices include compact-disk read-only memory (CD-ROM), Digital Versatile Disk read-only memory (DVD-ROM), memory stick, embedded ROM, or others.

Video compression and decompression refer to certain operations performed in a video encoder and/or decoder. A video decoder may perform all, or a subset of, the inverse operations of the encoding operations. Unless otherwise noted, techniques of video decoding described here are intended also to encompass the inverse of the described video encoding techniques (namely associated video decoding techniques), and vice versa.

Video compression techniques may perform spatial prediction and/or temporal prediction so as to reduce or remove redundancy inherent in video sequences. One class of video compression techniques utilized by or in relation to the aforementioned video coding standards is known as “intra coding”. Intra coding can make use of spatial prediction so as to reduce or remove spatial redundancy in video blocks within a given video unit, such as a video picture, but which may also represent less than a whole video picture (e.g., a slice, macroblock in H.264, or coding unit in WD3).

A second class of video compression techniques is known as inter coding. Inter coding may utilize temporal prediction from one or more reference pictures to reduce or remove redundancy between (possibly motion compensated) blocks of a video sequence. Within the present context, a block may consist of a two-dimensional matrix of sample values taken from an uncoded picture within a video stream, which may therefore be smaller than the uncoded picture. In H.264, for example, block sizes may include 16×16, 16×8, 8×8, 8×4, and 4×4.

For inter coding, a video encoder can perform motion estimation and/or compensation to identify prediction blocks that closely match blocks in a video unit to be encoded. Based on the identified prediction blocks, the video encoder may generate motion vectors indicating the relative displacements between the to-be-coded blocks and the prediction blocks. The difference between the motion compensated (i.e., prediction) blocks and the original blocks forms residual information that can be compressed using techniques such as spatial frequency transformation (e.g., through a discrete cosine transformation), quantization of the resulting transform coefficients, and entropy coding of the quantized coefficients. Accordingly, an inter-coded block may be expressed as a combination of motion vector(s) and residual information.

Quantization of data carried out during video compression, for example, quantization of the transformed coefficients of the residual information, may cause reconstructed sample values to differ from their corresponding sample values of the original picture. This loss of information affects negatively, among other things, the natural smoothness of the video pictures, which can yield a degradation of the quality of the reconstructed video sequences. Such degradation can be mitigated by loop filtering.

In the following, the term “loop filtering” may be used (unless context specifically indicates otherwise) in reference to spatial filtering of samples that is performed “in the loop”, which implies that the filtered sample values of a given reconstructed picture can be used for future prediction in subsequent pictures in the video stream. Because the filtered values are used for prediction, the encoder and decoder may need to employ the same loop filtering mechanisms (at least to the point where identical results are obtained by the same input signal for all encoder and decoder implementations), yielding identical filtering results and thereby avoiding drift. Therefore, loop filtering techniques will generally need to be specified in a video compression standard or, alternatively, through appropriate syntax added to the bitstream.

In some video coding standards, loop filtering is applied to the reconstructed samples to reduce the error between the values of the samples of the decoded pictures and the values of corresponding samples of the original picture. In H.264, for example, an adaptive de-blocking loop filtering technique that employs a bank of fixed low-pass filters is utilized to alleviate blocking artifacts. These low-pass de-blocking filters are optimized for a smooth picture model, which may not always be appropriate to the video pictures being encoded. For example, a video picture may contain singularities, such as edges and textures, which may not be processed correctly with the low-pass de-blocking filters optimized for smooth pictures. Moreover, the low-pass de-blocking filters in H.264 do not retain frequency-selective properties, nor do they always demonstrate the ability to suppress quantization noise effectively. However, it has been shown that one can reduce the quantization noise substantially and improve the coding efficiency significantly by applying loop filters not specifically designed for deblocking, for example, Wiener filters, which may perform effectively, or in some cases even near-optimally, for pictures that have been degraded by Gaussian noise, blurring and other (similar) types of distortion.

Many techniques in the area of loop filtering have been attempted since the ratification of the first version of H.264.

For example, in Steffen Wittmann and Thomas Wedi, “Post-filter SEI message for 4:4:4 coding,” ISO/IEC JTC1/SC29/WG11 and ITU-T SG16 Q.6, JVT-S030r1, Geneva, CH, 31 Mar.-7 Apr. 2006, which is incorporated herein by reference in its entirety, a form of adaptive post-filtering was proposed for use, in addition to de-blocking filtering, to reduce quantization errors inside individual blocks. The proposed approach involved application of an adaptive Wiener filter to the inner sample values of such individual blocks. Either the coefficients of the adaptive Wiener filter, or else the correlation coefficients utilized for the design of the adaptive Wiener filter, are made available to the decoder for their possible use in post-processing of the decoded pictures before displaying such pictures.

While the above technique attempted by Wittmann and Wedi may somewhat improve the quality of reconstructed video pictures, one associated disadvantage with their approach is that only the to-be-displayed pictures would be subjected to post-filtering. Re-use of Wiener-filtered pictures as reference pictures for further processing, such as in predictive coding, was generally disallowed. This restriction on the use of Wiener-filtered samples can limit, in some cases substantially, any resulting improvement in video quality because predictively coded pictures, by still referring to non Wiener-filtered samples, could re-introduce some of the artifacts the Wiener filter may have removed in the to-be-displayed picture. Another potential disadvantage is that even if the quality of a post-filtered picture is not better than that of the corresponding decoded picture in some areas, the post-filtered picture is still used, yielding an overall reduction in reproduced video quality for some sequences such as some sports sequences.

Another approach to loop filtering was proposed in T. Chujoh, N. Wada, G. Yasuda, “Quadtree-based adaptive loop filter,” ITU-T Q.6/SG16 VCEG, COM 16-C 181-E, Geneva, January 2009, which is incorporated herein by reference in its entirety. Their approach, referred to as Quadtree-based Adaptive Loop Filtering (QALF), involved an adaptive loop filtering technique (i.e., one that performs filtering inside the coding loop). According to QALF, a quadtree block partitioning algorithm is applied to a decoded picture, yielding variable-size luminance blocks with associated bits. The values of these bits indicate whether each of the luminance blocks is to be filtered using one of three (5×5, 7×7, and 9×9) diamond-shaped symmetric filters.

The QALF technique was modified in Marta Karczewicz, Peisong Chen, Rajan Joshi, Xianglin Wang, Wei-Jung Chien, Rahul Panchal, “Video coding technology proposal by Qualcomm Inc”, ITU-T Q.6/SG16, JCTVC-A121, Dresden, Del., 15-23 Apr. 2010, which is incorporated herein by reference in its entirety. Rather than a single filter of each dimension (e.g., 5×5, 7×7, and 9×9), in the modified QALF technique, it was proposed to allow the use of a set of different filters for each dimension. The set of filters is made available to the decoder for each picture or a group of pictures (GOP). Whenever the QALF partitioning map indicates that a decoded luminance block is to be filtered, for each pixel, a specific filter from the set of filters is selected that minimizes the value of a sum-modified Laplacian measure. Moreover, when a decoded luminance block is to be filtered, a 5×5 two-dimensional non-separable filter is applied to the samples of the corresponding (decoded) chrominance blocks.

While the above techniques can improve the video quality, one associated disadvantage is that the available filters are of only a single, fixed shape. In most cases, diamond-shaped filters are employed. This restriction on the shape of the filters can limit, in some cases substantially, the improvement in video quality for some video sequences. This limitation can also require the use of a large number of coefficients, which can be costly in terms of both side information and number of computations. For example, in order to specify 16 different 9×9 diamond-shaped symmetric filters, 336 coefficients are required. Moreover, the use of a 9×9 diamond-shaped filter requires 21 separate multiplication operations and 42 separate addition operations per filtered sample at the encoder/decoder (assuming the use of a symmetric filter as described below).

A need therefore exists for an improved method and system for adaptive loop filtering in the context of video encoding and/or decoding. Accordingly, a solution that addresses, at least in part, the above and other shortcomings is desired.

### SUMMARY

Embodiments of the present invention provide method(s) and system(s) for adaptive loop filtering of reconstructed video pictures during the encoding/decoding of digital video data.

According to an aspect of the invention, an encoder is configured and operable to generate and insert information into a bitstream, which a decoder can use later during decoding. In some cases, the information generated by the encoder may specify, impose or otherwise relate to limitations associated with filter shapes used for loop filtering of reconstructed samples, such as a maximum size, a maximum number of coefficients, and a maximum number of different shapes that can be used. The bitstream can contain such information.

According to an aspect of the invention, an encoder is configured and operable, for each video unit within a video sequence, to select one of one or more pre-defined filter shapes or a newly-generated filter shape for loop filtering of reconstructed samples. In such case, bits representing the selection made by the encoder can be inserted into the video unit header or other suitable syntax structure. Where the encoder selects a newly-generated filter shape for loop filtering, such filter shape may also be encoded, and the encoder may insert the resulting encoded bits into an appropriate syntax structure, such as a parameter set or a video unit header. Alternatively, in some cases, the encoder may insert the resulting encoded bits to represent the newly generated filter shape into another appropriate place in the bitstream. Alliteratively, in some cases, the resulting encoded bits may be sent out of band.

According to an aspect of the invention, a decoder is configured and operable to obtain a reference to a pre-defined filter shape or, alternatively, information allowing the decoder to reconstruct a newly-generated filter shape selected by an encoder. The referenced or reconstructed filter shape may be used by the decoder in a loop filtering phase of the decoding process. Depending on how the encoder is configured for transmission, the decoder may correspondingly be configured to obtain the reference or other information either from an appropriate place in the bitstream, such as a parameter set or a video unit header, or alternatively from out of band.

According to an aspect of the invention, novel filter shapes, such as a 9×9 cross shape, which have been shown to be advantageous for loop filtering in the context of WD3, may be used by either the encoder and/or decoder as pre-defined filters.

According to one aspect of the invention, there is provided a method for video encoding, comprising: selecting, for at least one video unit, one of at least two filter shapes; and, filtering at least one reconstructed sample with a filter of the selected shape. According to another aspect of the invention, there is provided a method for video decoding, comprising: obtaining one of at least two filter shapes; and, filtering at least one decoded and reconstructed sample with a filter of the selected shape.

In accordance with further aspects of the present invention there is provided an apparatus such as a data processing system, a method for adapting this apparatus, as well as articles of manufacture such as a computer-readable medium or product having program instructions recorded thereon practicing the method of the invention.

In one broad aspect, there is provided a method for video encoding. The method may include, in respect of at least one video unit, selecting a filter shape, and filtering at least one reconstructed video sample within the at least one video unit using a filter of the selected filter shape.

In another broad aspect, there is provided a non-transitory computer readable media having computer executable instructions stored thereon for programming one or more processors to perform a method for video encoding. The method may include, in respect of at least one video unit, selecting a filter shape, and filtering at least one reconstructed video sample within the at least one video unit using a filter of the selected filter shape.

In some embodiments, according to either of the above two aspects, the filter shape may be selected from a plurality of different filter shapes. In such cases, at least one filter shape in the plurality of different filter shapes may be pre-defined. In such cases, the at least one pre-defined filter shape may include a cross shape. In such cases, the cross shape may be a 9×9 cross shape.

In some embodiments, according to either of the above two aspects, the method may further include encoding filter specification information into a bitstream, the filter specification information including at least one of a maximum size of a filter shape, a maximum number of coefficient of a filter shape, or a maximum number of filter shapes.

In some embodiments, according to either of the above two aspects, the method may further include one of inserting filter shape information into a bitstream or sending the filter shape information out of band, the filter shape information identifying the selected filter shape. In such cases, the selected filter shape may be a newly generated shape.

In some embodiments, according to either of the above two aspects, the method may further include one of inserting coefficient information into a bitstream or sending the coefficient information out of band, the coefficient information representing at least one coefficient of a newly generated filter according to the selected filter shape.

In yet another broad aspect, there is provided a method for video decoding. The method may include receiving information indicative of a filter shape selected from a plurality of different filter shapes, and filtering at least one reconstructed sample within a video unit using a filter of the shape indicated by the received information.

In yet another broad aspect, there is provided a non-transitory computer readable media having computer executable instructions stored thereon for programming one or more processors to perform a method for video decoding. The method may include receiving information indicative of a filter shape selected from a plurality of different filter shapes, and filtering at least one reconstructed sample within a video unit using a filter of the shape indicated by the received information.

In some embodiments, according to either of the above two aspects, at least one filter shape in the plurality of different filter shapes may be predefined. In such cases, the at least one predefined filter shape may include a cross shape. In such cases, the cross shape may be a 9×9 cross shape.

In some embodiments, according to either of the above two aspects, the method may further include decoding filter specification information from a bitstream or from information received out of band, the filter specification information including at least one of a maximum size of a filter shape, a maximum number of coefficient of a filter shape, or a maximum number of shapes.

In some embodiments, according to either of the above two aspects, the method may further include decoding filter shape information from a bitstream or from information received out of band, the filter shape information identifying the selected filter shape. In such cases, the selected filter shape may be a newly generated shape.

In some embodiments, according to either of the above two aspects, the method may further include decoding coefficient information from a bitstream or from information received out of band, the coefficient information representing at least one coefficient of a newly generated filter according to the selected filter shape.

In yet another broad aspect, there is provided a method of video encoding. The method may include filtering at least one sample with a filter of a cross shape.

In yet another broad aspect, there is provided a non-transitory computer readable media having computer executable instructions stored thereon for programming one or more processors to perform a method of video encoding. The method may include filtering at least one sample with a filter of a cross shape.

In some embodiments, according to either of the above two aspects, the cross shape may be an n×n cross shape, n being any integer greater than or equal to 3. In such cases, n may be equal to 9.

In some embodiments, according to either of the above two aspects, the cross shape may be a degenerated cross shape.

In yet another broad aspect, there is provided a method of video decoding. The method may include filtering at least one sample with a filter of a cross shape.

In yet another broad aspect, there is provided a non-transitory computer readable media having computer executable instructions stored thereon for programming one or more processors to perform a method of video decoding. The method may include filtering at least one sample with a filter of a cross shape.

In some embodiments, according to either of the above two aspects, the cross shape may be an n×n cross shape, n being any integer greater than or equal to 3. In such cases, n may be equal to 9.

In some embodiments, according to either of the above two aspects, the cross shape may be a degenerated cross shape.

### BRIEF DESCRIPTION OF THE DRAWINGS

Further features and advantages of the embodiments of the present invention will become apparent from the following detailed description, taken in combination with the appended drawings, in which:

FIG. 1 is a diagram illustrating a video codec with a de-blocking loop filter and an adaptive loop filter in accordance with an embodiment of the invention;

FIG. 2 shows a number of exemplary 5×5 filter shapes in accordance with an embodiment of the invention;

FIG. 3 shows a number of exemplary filter shapes with 25 coefficients in accordance with an embodiment of the invention;

FIG. 4 shows a number of exemplary filter shapes with 19 coefficients and utilizing 7 line buffers in accordance with an embodiment of the invention;

FIG. 5 shows a number of exemplary filter shapes utilized 5 line buffers in accordance with an embodiment of the invention;

FIG. 6 shows a number of exemplary filter shapes with 9 coefficients in accordance with an embodiment of the invention;

FIG. 7 shows a flow diagram illustrating an example selection of a set of filters of a single shape in accordance with an embodiment of the invention;

FIG. 8 shows flow diagrams illustrating an example of encoding/decoding processes using a selected set of filters in accordance with an embodiment of the invention;

FIG. 9 shows flow diagrams illustrating exemplary encoder and decoder operations;

FIG. 10 is a block diagram illustrating a data processing system (e.g., a personal computer or “PC”) based implementation in accordance with an embodiment of the invention;

FIG. 11 shows a flow diagram illustrating exemplary encoder operations; and

FIG. 12 shows an exemplary filter shape of a 9×9 degenerated cross-shaped filter.

It will be noted that throughout the appended drawings, like features are identified by like reference numerals.

### DETAILED DESCRIPTION OF EMBODIMENTS

In the following description, details are set forth to provide an understanding of the invention. In some instances, certain software, circuits, structures, and methods have not been described or shown in detail in order not to obscure the invention. The term “data processing system” is used herein to refer to any machine for processing data, including the computer systems, wireless devices, and network arrangements described herein. Embodiments of the present invention may be implemented in any computer programming language and under any operating system, provided that the programming language and operating system of the data processing system provides the facilities that may support the requirements of these embodiments. Embodiments may also be implemented in hardware or in a combination of hardware and software.

At least some embodiments of the present invention relate to adaptive loop filtering of reconstructed pictures, or parts thereof (referred to as “pictures” henceforth for convenience), in the context of video encoding and/or decoding. The term “loop filtering” may be used to indicate a type of filtering that can be applied to the reconstructed pictures within the coding loop, with the effect that the reconstructed and filtered pictures can be saved and can be used as reference pictures for the reconstruction of other pictures in a video sequence.

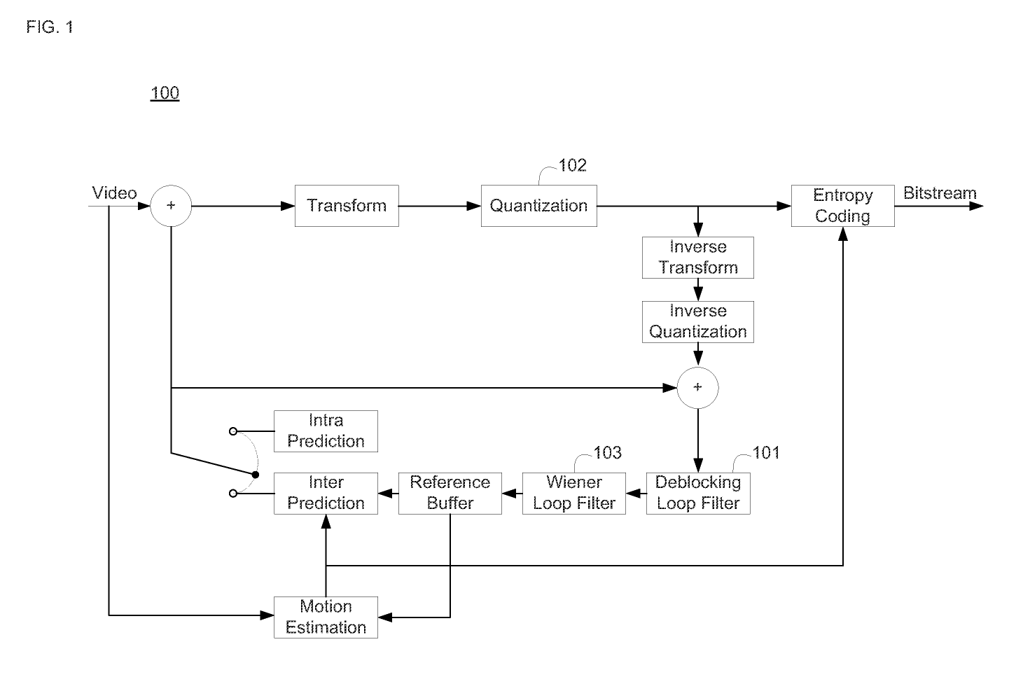

FIG. 1 shows a block diagram of the coding loop of a video encoder 100 that is operable to encode video sequences that are formatted into video units. The encoder 100 includes a de-blocking loop filter 101 and an adaptive loop filter 103, located in a filtering loop of the video encoder 100, in accordance with an embodiment of the invention. The de-blocking filter 101 may be configured to adaptively apply one or more low-pass filters to block edges and, in so doing, the de-blocking filter 101 can improve both the subjective and objective quality of the video being encoded in the encoder 100. Subjective quality may refer to quality of the reconstructed video or picture as perceived by an average human observer and can be measured, for example, by following ITU-R Recommendation BT.500. Objective quality may refer to any determination of video quality that can be expressed by a mathematic model based generally on a comparison between the original picture and a corresponding picture reconstructed from the bitstream. For example; one frequently used objective quality metric is known as Peak Signal-to-Noise Ratio (PSNR).

In some embodiments, the de-blocking loop filter 101 operates by performing an analysis of samples located around a block boundary and then applying different filter coefficients and/or different filter architectures (e.g., number of taps, Finite Impulse Response (FIR)/Infinite Impulse Response (IIR), as discussed below) so as to attenuate small intensity differences in the samples which are attributable to quantization noise, while preserving intensity differences that may pertain to the actual video content being encoded.

Such blocking artifacts that may be removed by the de-blocking loop filter 101 are not the only artifacts that can be present in compressed video and observable after reconstruction. For example, coarse quantization, which may be introduced by the selection of a numerically high quantizer value in the quantization module 102 based on compression requirements, may be responsible for other artifacts such as ringing, edge distortion, or texture corruption, being introduced into the compressed video. The low-pass filters adaptively employed by the de-blocking loop filter 101 for de-blocking may assume a smooth image model, which may make such low-pass filters perform sub-optimally for de-noising image singularities such as edges or textures. As used herein throughout, the term “smooth image model” may be used in reference to video pictures whose image content tends to exhibit relatively low frequency spatial variation and to be relatively free of high-contrast transitions, edges or other similar singularities.

Accordingly, the video encoder 100 may include an additional filter cascaded together with the de-blocking loop filter 101 and used to at least partially compensate for the potential sub-optimal performance of the low-pass filters configured within the de-blocking loop filter 101. For example, as seen in FIG. 1, the video encoder 100 may further include loop filter 103, which can be a Wiener filter, and which is configured to filter at least the inner sample values of some blocks of a video unit and thereby achieve a reduction or even elimination of the quantization errors inherent in such blocks.

As used in the present context, the term “video unit” may be defined so as to represent any syntactical unit of a video sequence that covers, at least, the smallest spatial area to which spatial filtering can be applied. According to this definition, for example, a video unit may encompass the spatial area covered by elements that in H.264 and older standards were referred to “blocks”. However, within the present context, a video unit can also be much larger than such blocks. For example, in some embodiments, the video unit may be an entire video picture or, alternatively, a spatial area that is less than an entire video picture, such as a slice, or some other grouping of contiguous or non-contiguous macroblocks. Henceforth, in order to simplify the discussion, and unless otherwise noted, the description will assume that each video unit is a video picture. Thus, by this assumption, the spatial area filtered by the loop filter 103 in accordance with a single filter shape will equate to a picture.

In video compression, spatial filters may be configured to process a plurality of spatially distributed samples. For each given sample, the spatial filters may additionally process one or more neighbouring samples, including samples located above, below, left, and/or right of the given sample that is being filtered. The locations of the neighbouring samples, relative to the sample being filtered, on which the spatial filter operates defines the shape of the filter, or filter shape. Based on the number and distribution of the neighbouring samples, different filter shapes are possible.

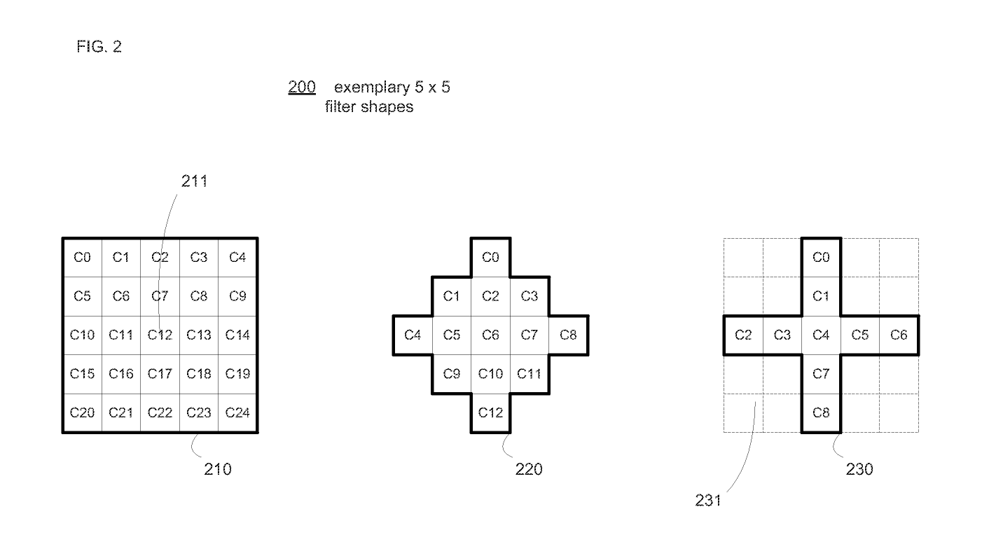

Referring now to FIG. 2, some exemplary filter shapes 200 are graphically represented in accordance with an embodiment of the invention. Each of the three filter shapes 200 describe a different 5×5 filter, i.e. a filter whose height and width are each 5 samples. (In general, an H×V filter will have a height of H samples and a width of V samples in their longest horizontal or vertical extent). In is also evident from FIG. 2 that each 5×5 filter shown extends a maximum of two samples in either the horizontal or the vertical direction from a central sample, i.e., the sample being filtered.

Filter 210 is a 5×5 rectangle-shaped filter comprising a matrix of 5×5 coefficients forming a rectangle, where the sample being filtered 211 is located in the center of the matrix. A spatial filter having the shape of filter 210 has 25 filter coefficients (i.e., C0-C24) and, assuming linearity and no exploitation of symmetry properties, will require 25 multiplications and 24 additions to filter a single sample (i.e., C12). Filter 220 is a 5×5 diamond-shaped filter which employs 13 filter coefficients (i.e., C0-C12) and, on the above assumptions, requires 13 multiplications and 12 additions to filter a single sample (i.e., C6). Also, filter 230 is a 5×5 cross-shaped filter which employs 9 filter coefficients (i.e., C0-C8), which would likewise require 9 multiplications and 8 additions to filter a single sample (i.e., C4). The number of filter coefficients used by each filter shape may be reduced by approximately a factor of two by exploiting symmetry properties, as described in more detail below.

The number of coefficients in a spatial filter is one measure of its complexity. Linear filters, which are common in image and video compression systems due to their relatively low complexity, may require approximately one multiplication operation and one add operation for every one filter coefficient. Accordingly, as noted, the rectangle-shaped filter 210, the diamond-shaped filter 220, and the cross-shaped filter 230 will require approximately 25, 13 and 9 multiplication and addition operations, respectively, in reflection of the number of coefficients within each. The number of multiplication operations, but not necessarily also the number of addition operations, can be reduced by approximately 50% by exploiting symmetry properties, as described in more detail below. However, in at least some cases, the number of addition operations performed can have no significant impact on complexity.

One observation from FIG. 2 is that the diamond-shaped filter 220 and the cross-shaped filter 230 can, in at least some contexts, be considered to be degenerate versions of the rectangle-shaped filter 210. As such, each of the diamond-shaped filter 220 and the cross-shaped filter 230 may be implemented or simulated using the rectangle-shaped filter 210. For example, the cross-shaped filter 230 can be represented by the rectangle-shaped filter 210 if certain coefficients in the rectangle-shaped filter 210 are zeroed. More specifically, this will be the case where all the coefficients located outside the cross are zeroed (zero coefficients are designated in cross-shaped filter 230 as regions 231 and also are shown through dashed lined blocks).

Filter shape degeneracy can be exploited in video compression standards where a decoder may generally be required to be able to process any compliant bitstream. Thus, if the syntax and semantics allow for a rectangle-shaped filter, such as the filter 210, it may not be efficient from a decoder cycle provisioning viewpoint to introduce additional filters shapes of the same size, such as the diamond-shaped filter 220 or the cross-shaped filter 230, if such additional filter shapes would be degenerate versions of the rectangle-shaped filter 210. In that case, because each degenerate filter shape may be realized through zeroing of coefficients in the rectangle-shaped filter 210, all the cycles necessary to filter a reconstructed sample using the rectangle-shaped filter 210 (which contains the maximum number of coefficients for a given H×V size) would already be provisioned in the decoder. As a result, distinguishing between the three different shapes shown in FIG. 2 may have, in some cases, only marginal effect on the complexity of a decoder. For example, using modern entropy coding techniques, such as Context-Adaptive Binary Arithmetic Coding (CABAC), the coding overhead for zero-valued coefficients can also be very—almost immeasurably and therefore insignificantly—low. Therefore, there may be relatively little incentive for a video codec designer to distinguish between the three shapes of FIG. 2.

While complexity is discussed above in terms of “cycles”—a measure that can be relevant in general-purpose CPU or DSP implementations—complexity could equally be discussed in other contexts using other metrics or measures. For example, in a Field-Programmable Gate Array (FPGA) implementation of a decoder, complexity can be characterized as a function of functional elements required for implementing the filter within the FPGA. As the number of such functional elements is limited and a cost factor (they occupy chip surface space), a smaller number of functional elements can generate cost advantages. For example, one type of functional element within an FPGA may be a multiply/add unit. An implementation of the rectangle-shaped filter 210 may require 25 multiply-add functional units, whereas an implementation of the cross-shaped filter 230 may require only 9 functional units. In some cases, a functional unit in an FPGA may be allocated for processing of more than one sample, in which case the count of functional units to implement a given filter shape would be reduced accordingly. However, one potential trade-off to such allocation is that the functional units may also be required to operate multiple times faster (e.g., twice as fast if allocated to two samples, or three times as fast if allocated to three samples), and that can also incur cost. For convenience, despite any operative differences between software and hardware implementations of decoders, cycle count will be used as a measure of complexity for both software and non-software implementations.

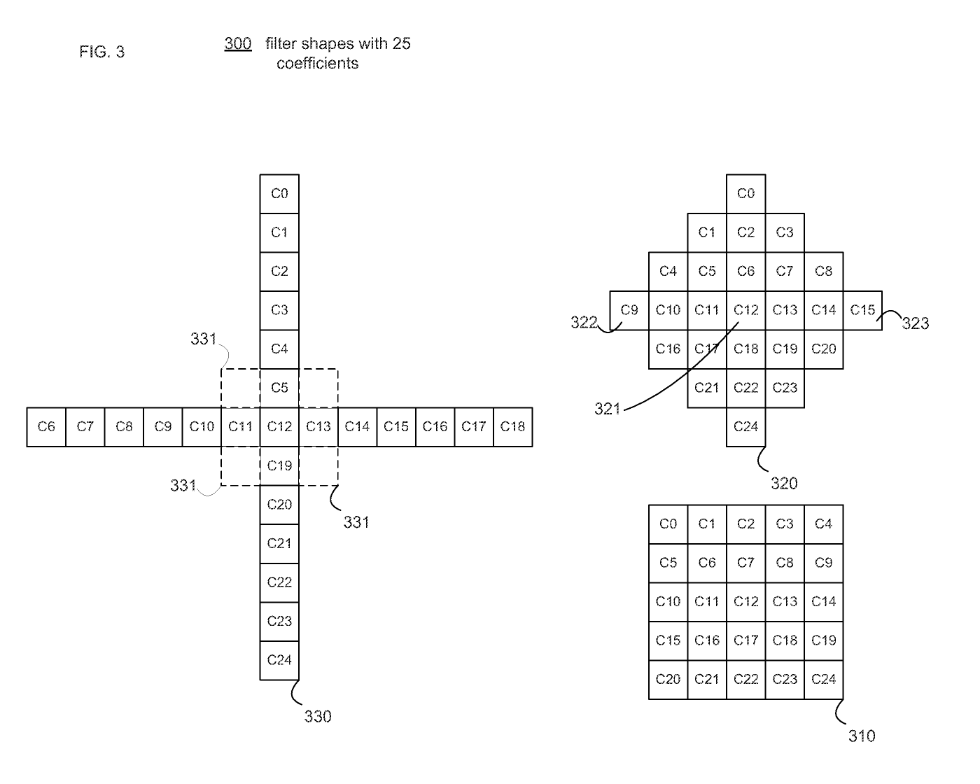

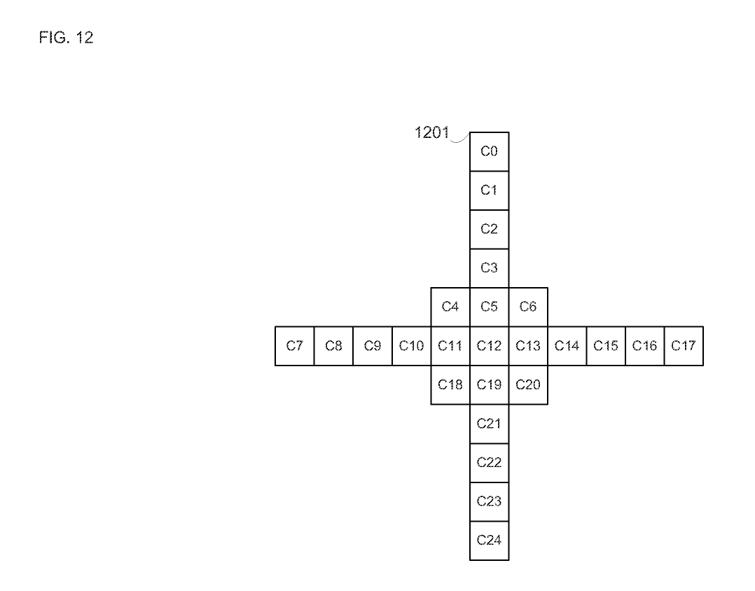

FIG. 3 and FIG. 12 show four exemplary filter shapes, each such filter shape formed with the same number of coefficients, in this case 25 coefficients (which can be reduced to 13 coefficient by exploiting symmetry properties, as described below), but having different sizes. More specifically, there is shown (in FIG. 3) a 5×5 rectangle-shaped filter 310, a 7×7 diamond-shaped filter 320, a 13×13 cross-shaped filter 330, and (in FIG. 12) a 11×11 degenerated cross-shaped filter 1201, in accordance with an embodiment of the invention. Since each filter shown contains an equal number of coefficients, approximately the same number of operations will be required by each to process a given sample. However, due to their different sizes, the filters shown will cover generally different spatial areas and will reflect correspondingly different “localities”.

More specifically, the 5×5 rectangle-shaped filter 310 may be considered to be very “local”, relative to the other two filters shown, in that the maximum distance between the sample being filtered (i.e., C12) and the outmost samples in either the horizontal or vertical direction (i.e., C2, C10, C14, C22) is only two samples. Filter shapes with such characteristics can be particularly useful when filtering a picture (or picture part) with fine detail, sharp edges, and/or other similar singularities. In contrast, the 13×13 cross-shaped filter 330, while having the same number of coefficients, extends the area from which samples are taken for filtering to a 13×13 matrix. Accordingly, the maximum distance between the sample being filtered (i.e., C12) and the outmost samples in either the horizontal or vertical direction (i.e., C0, C6, C18, and C24) is six samples. Such filter shapes may be best suited in pictures or picture parts with flat content and high resolution, such as a “blue sky”. In between these two relative extremes, the 7×7 diamond-shaped filter 320 again has 25 coefficients, but the maximum distance between the sample being filtered (i.e., C12) and the outmost samples in either the horizontal or vertical direction (i.e., C0, C9, C15, and C25) is three samples. Such shape as is exhibited by the filter 320 may be suitable for moderately active pictures or picture parts, whereas the shape of the 11×11 degenerated cross-shaped filter 1201, with five samples maximum distance and 8 coefficients at a distance of only a single sample, may be suitable for generally flat content with occasional, but prominent, singularities.

Depending on application and/or context, the exemplary filters shown in FIG. 3 may have very different performance levels for different video content, as described above.

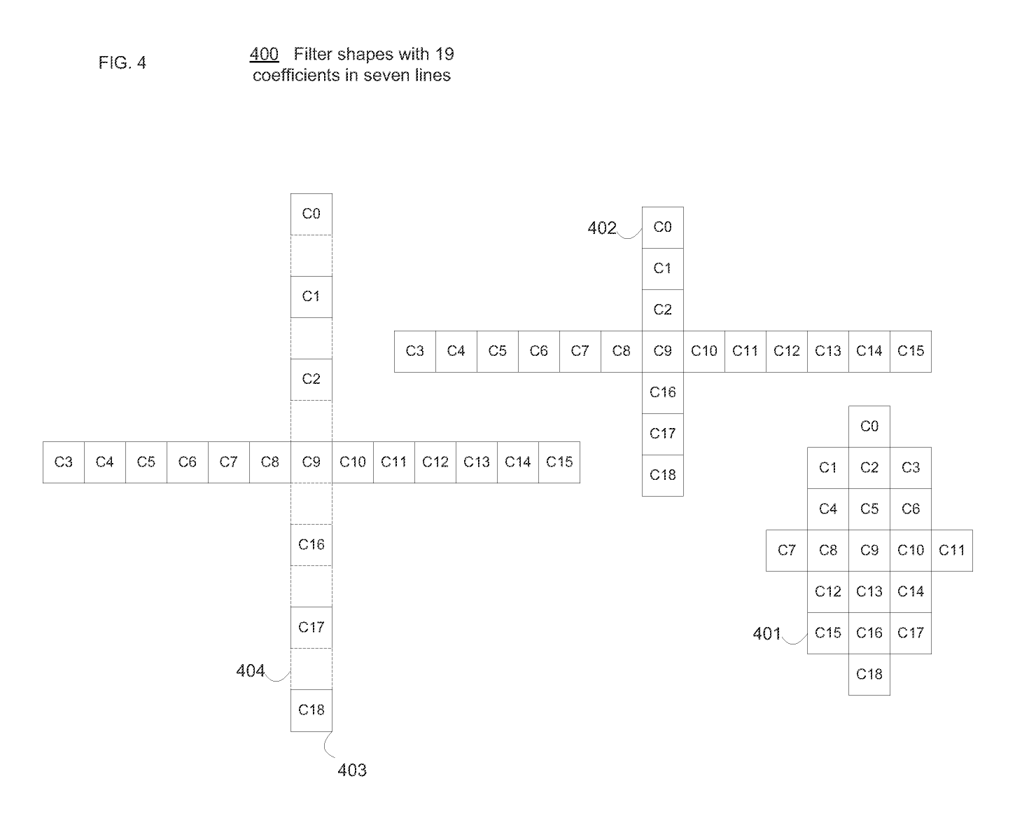

Referring now to FIG. 4, it is also possible to define non-squared filter shapes, in contrast to the exemplary shapes shown in FIGS. 2, 3, and 12, which all have squared profiles. In at least some contexts, non-squared filter shapes have been shown to produce results better than the more traditional diamond or rectangular filters using a similar limited number of coefficients. These non-squared filter shapes can further have advantages in practical implementations, as described below. Three such filters shapes 400 are shown in FIG. 4, in accordance with an embodiment of the invention.

The filter shapes 400 exhibit certain commonalties. For example, each filter shape 400 uses 19 coefficients (which can be reduced to 10 coefficients by exploiting symmetry properties, as described below) located in exactly seven lines of samples only (potentially with skipped sample lines therebetween from which the filter shape draws no samples). One reason for, or advantage to be had by, imposing a restriction of the number, and variation in number, of coefficients in each filter shape has already been discussed above, namely to provide different filters of similar complexity according to the shape, as complexity can be dependent in some or large part on the number of coefficients used. Imposing a further restriction on the number of sample lines from which the filter shapes may draw samples may be convenient or advantageous based on hardware architectures used to implement the filter. Especially in large image formats, it is possible or even likely that each horizontal line of samples within a video picture will be allocated entirely to a given cache line, storage area in internal memory of a Digital Signal Processor (DSP), or a similar fast-access data structure. Accordingly, the more such sample lines a filter shape draws samples from in order to filter, the more cache lines, internal storage, and so forth, will generally be required for efficient execution of the filter.

Within the context of the above considerations and/or imposed limitations, FIG. 4 shows three different exemplary filter shapes. As noted, each of the depicted filter shapes utilize seven sample lines and 19 coefficients, but their different shapes correlate to different performances with respect to video content.

The exemplary filter shapes 400 include a 5×7 modified diamond shaped filter 401. The filter 401 employs all available 19 coefficients (that are the imposed upper limit from a complexity viewpoint) in a local setting so as to constrain the horizontal and vertical extent of the filter 401. In some cases, the filter 401 can be advantageously employed for video content with a lot of details.

Also shown is a modified 13×7 cross-shaped filter 402, which also uses all available 19 coefficients, but which covers a much larger horizontal area for filtering as compared to the 5×7 modified diamond shaped filter 401. The filter 402 can be advantageously employed for video content with less fine detail (as compared to video content for which the filter 401 may perform more effectively).

Finally, the modified 13×7 cross-shaped filter 403 is similar to the filter 402, except that samples of the vertical bar of the cross (i.e., C0-C3 and C16-C18) are spaced out to leave one scan line 404 between each filter samples in the vertical bar. In many cases, the filter 403 may provide similar response to a 13×13 cross-shaped filter (i.e., the cross-shaped filter 330 shown in FIG. 3, which may respond better to coarse detail content such as, for example, a blue sky, than would the filters 401 and 402,). However, unlike the cross-shaped filter 330, the filter 403 uses only 19 coefficients across 7 sample lines, which tends to reduce complexity.

Filters with such “interleaved” sample structures, of which the filter 403 is an example, are often not used in practice due to possible aliasing issues that may arise from such use. While the filter 403 may also exhibit aliasing, embodiments of the present invention may be operable to both detect possible aliasing issues and, when detected, select a different filter shape other than the filter 403 for use, for example the filters 401 or 402.

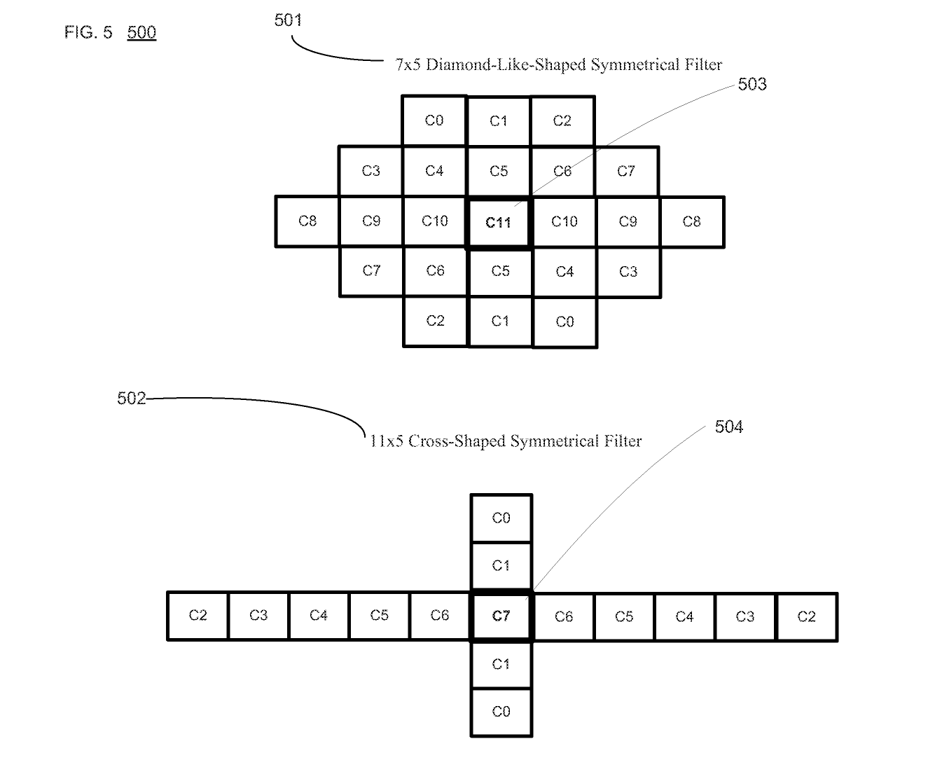

Referring now to FIG. 5, there are shown two additional exemplary filter shapes 500 that may be used within the loop filter 103 of FIG. 1 (and its counterpart in the decoder, not shown) to filter samples, in accordance with an embodiment of the present invention. In particular, there is shown exemplary shapes for a 7×5 diamond-like-shaped symmetric filter 501 and for an 11×5 cross-shaped symmetrical filter 502. The filter 501 is centered on coefficient C11 (at center position 503) and the filter 502 is centered on coefficient C7 (at center position 504). As above, the center positions 503 and 504 may represent the positions of the subject sample that may be filtered, respectively, by the filters 501 and 502. The remaining coefficients may represent the positions of the additional neighboring samples that may be processed during the loop filtering.

The filters 501 and 502 are also used herein to exemplify the symmetry properties exhibited by some filters. As shown, the filter 501 and 502 exhibit forms of horizontal, vertical and diagonal symmetry in their coefficients. Thus, in filter 501 coefficients C1 and C5 are reproduced both above and below C11 offset in each case by the same number of samples either side of C11. Likewise, coefficients C8, C9, and C10 appears both to the right and to the left of C11, again, offset in each case by the same number of samples either side of C11. The remaining coefficients C0, C2, C3, C4, C6, and C7 are related to C11 through a form of diagonal symmetry, as can be seen in FIG. 5. Horizontal and vertical symmetry is also exhibited in the filter 502. The filters shown in FIGS. 2, 3, 4, and 12 can, in some cases, be specified using a similar property.

Owing to such symmetry, the filter 501 may be specified by only 12 (as opposed to 23) coefficients, whereas the filter 502 may be specified by only 8 (as opposed to 15) coefficients. Accordingly, the two filters 501 and 502 have different complexities, and the difference in this case may be approximately 150% in complexity. As configured, the filter 501 may be optimized or pseudo-optimized to be “local”, whereas the filter 502 covers a relatively larger spatial area horizontally and therefore may be more suitable than the filter 501 for filtering less localized content. Each filter 501 and 502 spans five lines of samples in the vertical sense and, correspondingly, may require five line buffers or analogous data structures in at least some practical implementations.

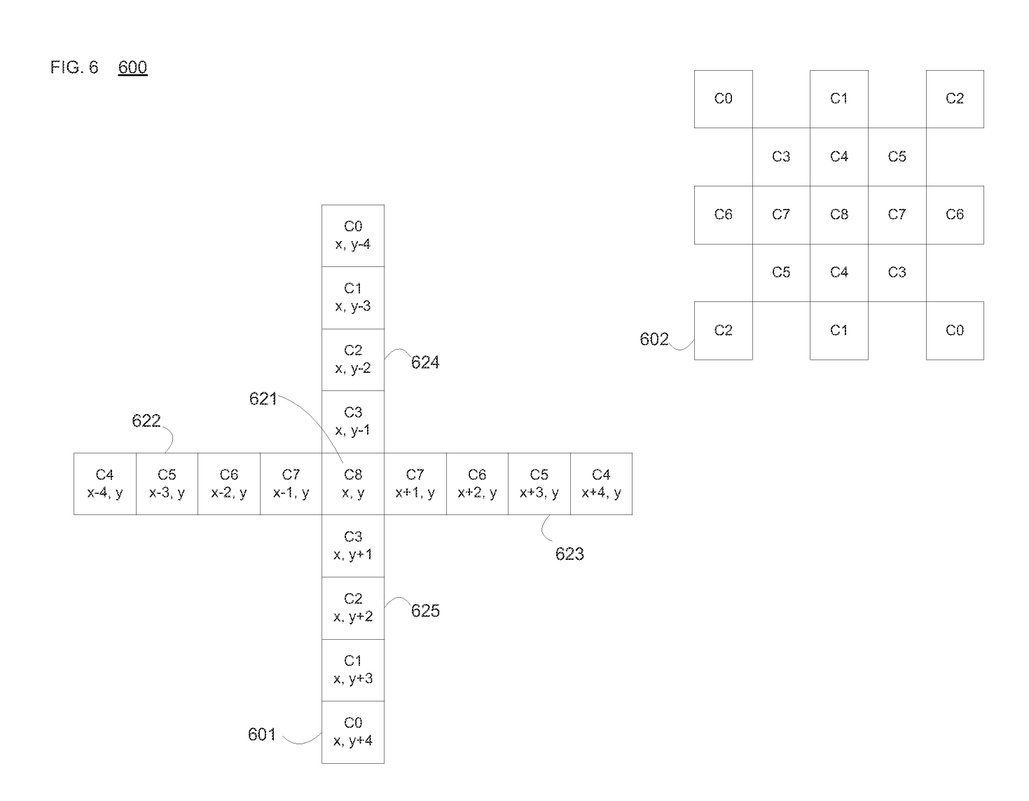

Referring now to FIG. 6, there is shown yet another set of exemplary filter shapes 600. More specifically, there is shown a 9×9 cross-shaped filter shape 601 and a 5×5 “snowflake” shaped filter shape 602. With complete generally, each of the filter shapes 601 and 602 may utilize 17 coefficients, i.e., a different coefficient for each sample spanned by the corresponding filter shape. However, as with the filters 501 and 502 of FIG. 5, by exploiting symmetry properties, the number of unique coefficients in each of the filters 601 and 602 may be reduced to 9 coefficients for a practical specification. In some cases, the cross-shaped filter 601 may exhibit excellent quality for generally smooth video content, and it has been shown experimentally to be excellent for video content with large camera “pan” and “zoom” effects. In contrast, the snowflake shaped filter 602 is comparatively localized and may exhibit responses that, in at least some respects, are substantially as good as a rectangular filter of the same dimensions. Further discussion of the snowflake shaped filter 602 may be found in Wang (PoLin) Lai, Felix C. A. Fernandes, Hsan Guermazi, Faouzi Kossentini, and Michael Horowitz, “ALF using vertical-size 5 filters with up to 9 coefficients”, ITU-T Q.6/SG16, JCTVC-F303, Torino, Italy, 14-22 Jul. 2011, which is incorporated herein by reference in its entirety.

Still other filter shapes not specifically discussed herein may also be suitable for certain loop filtering applications within the context of the present disclosure.

In the following discussion, reference is made to a “filter set” or “filter sets”. As used herein throughout, a (non-empty) filter set of a certain filter shape may comprise one or more filters each of which having coefficients arranged according to the filter shape which forms the basis for the filter set. Thus, a filter set may comprise one or more filters of the same general shape, but having differently valued coefficients. For example, each of the exemplary filter shapes shown in FIGS. 3-6 and 12 may form the basis of a filter set that comprises one or more filters of the depicted filter shapes, respectively.

Filter sets may be utilized in some loop filter techniques, such as the modified QALF technique discussed above, to extend the performance of loop filtering beyond the capabilities of a single fixed filter. When filtering with use of a filter set as opposed to a single fixed filter, a determination is made as to which particular filter in the filter set should be selected and applied to the sample. Different approaches to making this determination are possible and will not be discussed in great detail. However, one possible approach to filter selection is described by Karczewicz et al. in relation to the modified QALF technique. For convenience, the following description assumes use of filter sets to perform loop filtering. However, the described embodiments may equally be practiced with use of a single fixed or adaptively chosen filter (a degenerated form of a filter set that only includes a single filter), if necessary, with appropriate modification and/or alteration of these embodiments.

Video quality levels that are suitable to the purpose, based on objective and/or subjective quality factors, may be achieved by adaptation of both the filter coefficients in the filters of a given filter set, and potentially of the filter shapes themselves, to the content of the video sequence being filtered. Thus, as already described, certain filter shapes may be better suited to filtered certain types of video content and, within those better suited filter shapes, differently valued coefficients may achieve different performance levels for the filters. Mechanisms for adaptively and efficiently selecting one of several sets of pre-defined filters (i.e., with each filter set containing only a single filter shape) and/or a set of newly generated filters of a single filter shape are described in co-pending U.S. patent application Ser. No. 13/350,243, filed Jan. 13, 2012, entitled “ADAPTIVE LOOP FILTERING USING TABLES OF FILTER SETS FOR VIDEO CODING”, which is incorporated herein by reference in its entirety.

Embodiments of the present invention may be operable, for each video unit in an encoder, to select (in some cases adaptively) a particular filter shape for use in a de-blocking loop filter, as well as to encode a reference or other syntax structure that indicates the selected filter shape, and/or encode information sufficient to specify a newly-generated filter shape (as opposed to a pre-specified filter shape). Embodiments of the present inventions may further be operable to receive and use this encoded information in the loop filter of a decoder that is configured to decode video sequences which have been encoded by the encoder.

In some embodiments, the encoder and decoder may store filter size information related to the maximum size of a filter shape that may be used by the encoder in the coding of a video sequence. Such filter size information may, for example, be stored in the form of two pre-defined integer-valued variables, MaxSizeX and MaxSizeY, which represent horizontal and vertical maximum dimensions, respectively. Thus, for example, MaxSizeX=13 and MaxSizeY=13 would represent minimum values for these variables so as to enable the encoder to use the exemplary filter shapes 300 shown in FIG. 3 (i.e., which have dimensions of 13×13). However, larger values for MaxSizeX and MaxSizeY would still enable use of the exemplary shapes 300. The filter size information can be standardized (for example, in a profile or level section of a video coding specification) and hard coded, or alternatively can be coded as part of a high level syntax element such as a sequence parameter set which is included in a bitstream, or alternatively can be conveyed out of band, i.e. as a side effect of a session setup in a video conferencing system or streaming session. The term parameter set, as used herein, can refer to high level syntax structures that define parameters applicable for a sequence of pictures (sequence parameter set) or an individual picture (picture parameter set). As such, the sequence and/or picture parameter sets can be the syntax structures of the same name as specified in H.264 and WD3, or alternatively can refer to structures with similar uses such as the sequence, Group Of Pictures, or picture headers in other video coding standards. The filter size information may be useful, for example, in deciding how to allocate memory resources for efficient filtering of video units and/or to optimize caching.

In some embodiments, the encoder and decoder may store sample line information related to the maximum number of sample lines from which a filter may obtain samples. For example, the sample line information may be a number between 1 and MaxSizeY, as defined above. Thus, the number of sample lines from which samples are obtained may equal MaxSizeY (e.g., as in filters 401 and 402 of FIG. 4), but may also be some number less than MaxSizeY (e.g., as in filter 403 of FIG. 4, which contains “interleaved” coefficients). In some cases, the sample line information may be used by the encoder in determining when to interleave filter coefficients with sample lines that do not contribute neighbouring samples to the filter (e.g., as in filter 403). Specification of the sample line information may allow for more efficient resource allocation in the decoder, as the decoder may be made aware of the maximum number of sample lines that will need to be stored in internal memory for efficient operation.

In some embodiments, the encoder and decoder may store coefficient number information related to the maximum number of coefficients that will be used in loop filtering. Again using the exemplary filter shapes 300 shown in FIG. 3 as an example, a minimum number of 25 coefficients would need to be stored in order to enable use of the filter shapes 300 (i.e., because each depicted shape utilizes 25 coefficients). However, storage of a larger number of coefficients would also enable use of the exemplary shapes 300. The coefficient number information can be standardized (for example, in a profile or level section of a video coding specification) and hard coded, or alternatively can be coded as part of a high level syntax element such as a sequence parameter set which can be included in a transmitted bitstream, or alternatively can be conveyed out of band. The coefficient number information may be useful, for example, in deciding how to allocate computational resources for a loop filter in the encoder, and/or in deciding whether or not the decoder is capable of decoding a given video sequence.

In some embodiments, the encoder and decoder may store shape number information related to the maximum number of different shapes that can be used in loop filtering of a video sequence. For example, the shape number information may be used to determine the size of a shape table. Continuing the example of the exemplary filter shapes 300 shown in FIG. 3, the stored table would need to have at least three entries to enable use of the exemplary filter shapes 300 (i.e., because three unique shapes are defined for potential use), and the shape number, therefore, would have to be a minimum of 3. The shape number information can be standardized (for example, in a profile or level section of a video coding specification) and hard coded, or alternatively can be coded as part of a high level syntax element such as a sequence parameter set which can be included in a transmitted bitstream, or alternatively can be conveyed out of band. The shape number information may be useful, for example, in deciding how to allocate memory resources for different possible filter shape specifications.

In some embodiments, an encoder may store a table of different filter shapes in appropriate data structures or other appropriate representations. The size of the table can be based on or related to the maximum number of different shapes, as described above. The different filter shapes in the table can be pre-configured and hard-coded, for example, because the different shapes have been standardized as part of a video compression standard. As an example, the two exemplary shapes 600 of FIG. 6 could form part of a video compression standard and, consequently, be hard-coded into both the encoder and decoder. Owing to standardization, it may be possible for the decoder to select configure a filter exhibiting on the exemplary shapes 600 without shape information being explicitly conveyed by an encoder. Rather a reference to the selected, standardized shape may suffice. Alternatively, or perhaps in addition, the encoder may generate (in some cases content-adaptively) one or more definitions of non-standardized filter shapes. So as to enable use of the non-standardized filter shapes within the decoder (which would not be pre-configured for such use), the encoder may make all necessary information available to the decoder by writing the coded newly-generated shape definition(s) into, for example, a video unit header, parameter set, or other appropriate syntax structure within a bitstream, or alternatively by conveying such information to the decoder out of band.

In some embodiments, at least one of the two filter shapes 601 and 602 is a pre-configured filter shape, which may therefore be hard-coded into the encoder and/or decoder.

In some embodiments, filter shapes (including newly generated, non-standardized filter shapes) may be defined in the form of a bitmap of size MaxSizeX by MaxSizeY, wherein the position of each coefficient that is included as part of the filter shape may be denoted with a “1”. Locations of omitted or “zeroed” coefficients may be denoted in the bitmap with a “0”.

In some embodiments, an encoder may be operable to chose between more than one shape when filtering the samples of a video unit. Such selection may be made by the encoder according to different mechanisms or processes, example of which are described in greater detail below. The selected shape may be encoded into a video unit header, for example, in the form of an index into a table of different shapes. Alternatively, the selected shape may be encoded by explicit identification of coefficient locations within the filter shape, for example, using the above-described bitmap definition.

In some embodiments, the encoder may be configured for manual selection of filter shape to be applied for a video unit, for example, in the form of a user selection in video editing software.

In some embodiments, the encoder may be configured for automatic, internal selection of filter shape to be applied for a video unit.

In some embodiments, the encoder may be configured for selection of filter shape by a process that involves the encoder loop-filtering all or a subset of the samples of a video unit using filters of at least two different filter shapes, and then selecting one of the filter shapes based on certain performance metrics or criteria defined so as to obtain desirable results.

In some embodiments, the encoder may be configured to use more than one filter for each filter shape, wherein the available filters may be organized into one or more filter sets, as describe above. Further discussion of how to generate (including adaptive generation based on content characteristics), select, and use multiple filters of the same filter shape may be found in co-pending U.S. patent application Ser. No. 13/350,243. Further discussion on how to select an individual filter for application to a given sample may also be found in Marta Karczewicz et al. in relation to the modified QALF technique. Further details for how to select a filter set are provided below.

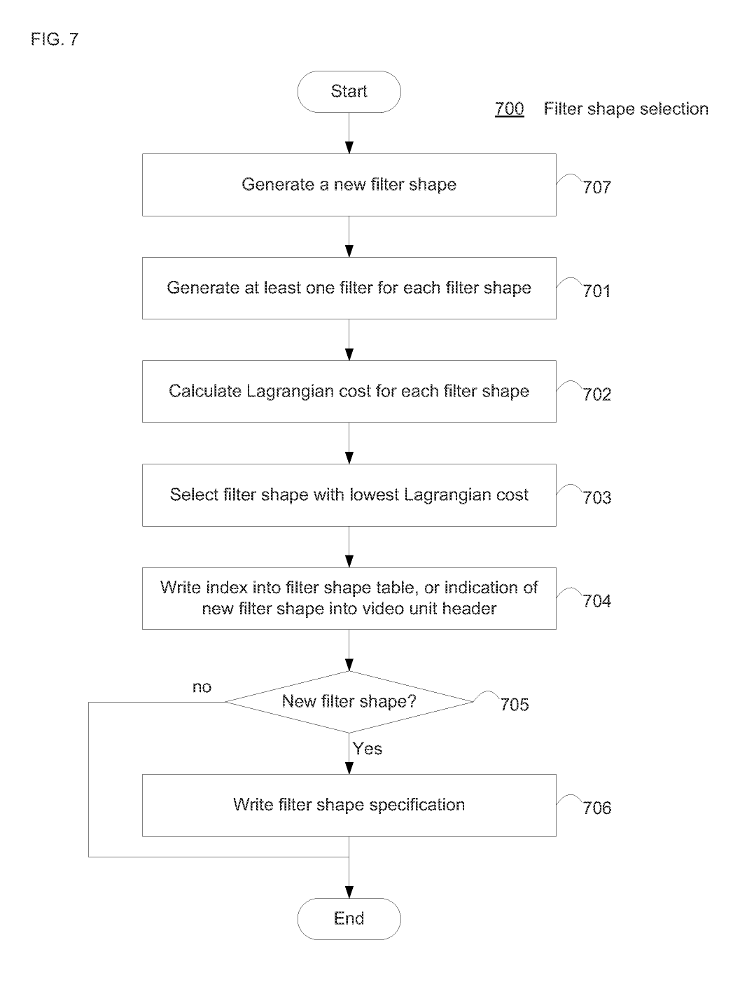

Referring now to FIG. 7, there is shown a flow diagram illustrating an exemplary method 700 for filter shape selection, in accordance with an embodiment of the invention. According to the method 700, for each video unit, a filter shape selection may involve either selecting one filter shape from a plurality of predefined filter shapes or, alternatively, selecting a newly generated filter shape (and at least one newly generated filter set comprising at least one newly generated filter according to the newly generated filter shape). For convenience, in the following discussion, it also is assumed that at least some video compression standards specify a finite number of filter shapes that may be used. The method 700 may be performed, for example, in the loop filter 103 of encoder 100 shown in FIG. 1.

The method 700 may comprise, for each video unit, generating (707) a new filter shape. Such generation can involve, for example an analysis of the picture for aspects such as smoothness, number and prominence of singularities, and other aspects. Based on this analysis, the horizontal and vertical size of a shape can be determined and the find shape can be created, in at least some cases by utilizing an upper bound of the number of coefficients allowed.

For each shape in the shape table, which may include multiple pre-defined shapes as well as the newly generated shape, at least one filter can be generated (701). Some mechanisms for filter generation are described in co-pending U.S. patent application Se. No. 13/350,243.

Then, for each available filters (including filter(s) generated in accordance with pre-defined shapes and the newly generated shape)), a Lagrangian cost may be computed (702). In some cases, such computation (702) may take into account any or all of source sample values, filtered sample values, and associated costs for coding each given filter and/or reference to each given filter, as the case may be. Different computations (702) of Lagrangian cost may be possible. For example, the Lagrangian cost may be computed in a rate-distortion sense by defining costs associated with both distortion that occurs due to filtering and bit requirements for coding different filter shapes (and associated filters or filter sets), and which are scaled using a selected multiplier. Thus, the Lagrangian cost may be computed by adding mean squared errors between corresponding samples in the original video unit and the filtered video unit (where each sample of the video unit is filtered using the filter), and to that sum adding a bias that is a function, through the selected multiplier, of the number of bits required to encode the filter shape (reference or shape information), as well as the filter or set of filters in a bitstream. In a particular case, the Lagrangian cost can be computed using the mode-decision-algorithm (Lagrangian) multiplier, although other computations and/or formulations of a suitable Lagrangian multiplier may be possible as well.

The filter shape (and associated filter or filter set) with the lowest computed Lagrangian cost can be selected (703) for use. Such selection (703) may be indicated differently based on the nature of the selected filter shape. For example, if the selected filter shape is pre-configured and, therefore, stored in a table or the like, the filter shape reference (e.g., an index into the filter shape table) can be inserted (704) into the video unit header within the bitstream. Alternatively, if the selected filter shape is a newly generated shape, indication that a newly generated (as opposed to pre-configured) shape is to be used may be inserted (704) into the video unit header. In the latter case, the indication of a newly generated filter shape can, for example, have the form of a reserved codeword in the same numbering space as is used for the indices into the filter shape table (i.e., a “dummy” index with no corresponding entry in the filter set table).

If a newly generated filter shape was selected (in 703), then the method 700 branches (705) and a specification of the newly generated filter shape (i.e., shape description, and filter set comprising filters, each comprising coefficients, etc.) is inserted (706) into the video unit header, parameter set, or other syntax structure within the bitstream. Alternatively, the specification of the newly generated filter shape may be conveyed out of band to the decoder. The resulting bitstream and other information (i.e., out-of-band information) is then made available to the decoder, for example, by transmission from the encoder. At this point, method 700 may end.

If, however, a set of newly generated filter was not selected (in 703), then method 700 may end directly, bypassing (705) the insertion (in 706). In this case, insertion of a filter shape specification may not be required due to selection of a pre-configured, standardized filter shape (i.e., which may already be hard-coded into the decoder). In some cases, at least one filter may still be transmitted, for example, as described in co-pending U.S. patent application Ser. No. 13/350,243.

In some embodiments, for a given video unit, an encoder may be configured and operable to include the coefficients of a filter of a selected filter set of a given shape within the video unit header. In this case, it may be convenient or advantageous in at least some contexts to minimize the amount of information to be conveyed within the video unit header. For example, transmission bandwidth may be limited or expensive so as to make it advantageous to reduce the overall amount of data transmitted. In some cases, processing speed requirements may provide the advantage in reducing data transmission. In general, even if the encoder does not include the filter coefficients within the video unit header, but instead conveys such information out of band (e.g., in a parameter set or other not real-time-decoded data structures), it may still be convenient or advantageous to minimize the amount of information related to filter coefficients that is to be conveyed, at least for the above-noted reason(s) or for any other reason.

The above-described method 700 for filter shape selection can be especially useful for application to video units which are large and relatively well-defined, for example, video units spanning an entire video picture, or a slice, or a large, preferably (though not necessarily) rectangular area of a video picture.

In some cases, such as for smaller video units, it may be possible for the filter information (including selection of shape and filter coefficients) to be stored within a video unit header, such as a Coding Unit header or a macroblock header. In these cases, it is also possible that the stored filter information may advantageously be applied to more than one video unit.

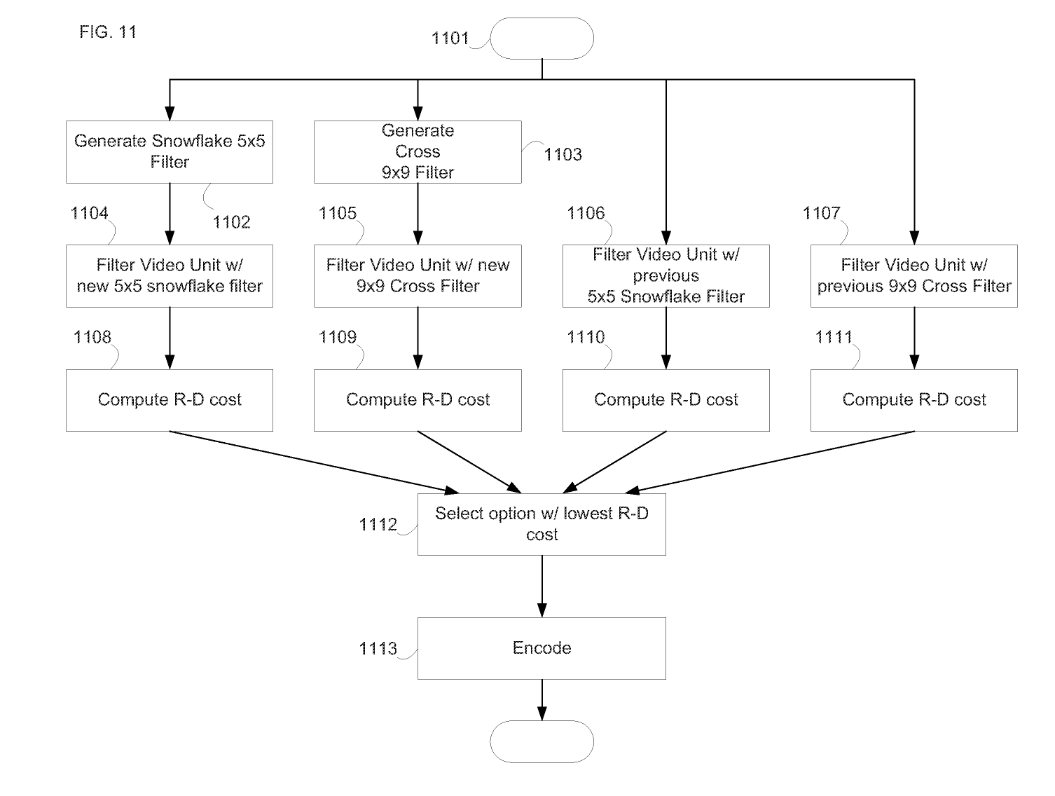

Referring now to FIG. 11, there is illustrated a method 1100 for selecting filter shape, in accordance with embodiments of the present invention, which may usefully be applied to smaller video units of the kind that stored filter information may apply to more than one. For convenience, the method 1100 will be described with reference to two pre-defined shapes, such as the 9×9 cross-shaped filter 601 and the 5×5 snowflake shaped filter 602 depicted in FIG. 6. However, embodiments of the present invention may extend the method 1100 to more than two different pre-defined filter shapes, and/or to a newly generated filter shape, as the case may be. The method 1100 may be performed, for example, using the loop filter 103 in encoder 100 shown in FIG. 1. Further, for convenience, for each filter shape, a filter set of the size of a single filter is described.

According to the method 1100, selection between the two pre-defined filter shapes may be made on a per video unit basis. For each of the two utilized shapes, new filters can be generated or, alternatively, previously generated (or in some cases default) filters can be re-used. Based on the outcome of the method 1100, one of four different filters will be selected for application to the video unit. These include “new” (i.e., generated in the context of a present video unit and applied to the present and possibly following video unit(s)) and “previous” (i.e., generated in the context of an earlier video unit) versions of each of the two utilized filter shapes, accounting for four different filters overall. (Of course, this number may vary in alternative embodiments that utilize a greater number of filter shapes and/or a newly generated filter shape. If three different pre-defined filter shapes were utilized, “new” and “previous” versions of each would account for six different filters overall. (If the number of filters in the filter set, per shape, would be larger than one, then the number of filters would increase accordingly.)

The selection of a given filter may be based on a Lagrangian cost computed for each option, which may again be defined in a rate-distortion (R-D) sense. In some cases, an R-D cost associated with each filter may be calculated, and whichever filter has the lowest associated R-D cost may be selected for application to the video unit. Certain parameters (such as, a change in filter shape, and/or coefficients for the filter shape selected) relating to the selected filter may be encoded, for example, in the NAL unit header. Some or all of these computations may be performed in parallel, thereby allowing for a degree of parallelization within the encoder.

Because according to the outcome of the method 1100, a given filter may be applied to both present and one or more previous video units being filtered, the method 1100 may result in a filter of a certain specification being applied to more than one video unit, as noted above. How this determination is made will now be described.

More specifically, after starting (1101) a loop filtering process for a given video unit being filtered (i.e., the “present” video unit), new filters are generated for each utilized filter shape. Thus, a new snowflake shaped filter is generated (1102) and also a new cross shaped filter is generated (1103). These new filters can be computed analytically, for example, as described in co-pending U.S. patent application Ser. No. 13/350,243.

Using the newly generated filters of the two shapes together with the previous versions, the present video unit can be filtered (1104, 1105, 1106, 1107) in four separate processes, one for each filter. Thus, the present video unit may be filtered using each of the new snowflake shaped filter (1104), the new cross shaped filter (1105), the previous snowflake shaped filter (1106), and the previous cross shaped filter (1107), respectively. In the cases of the two “previous” filters, either a default or a previously generated filter may be used.

A rate-distortion analysis can then be performed (1108, 1109, 1110, 1111) to provide a measurement of filter performance for each utilized filter. The rate-distortion analysis may be performed by, for example, calculating the rate associated with encoding shape information and filter coefficients for each filter, together with a measure of distortion associated with application of that filter, for example, which may take the form of a sum of absolute error of sample values. Based on these computations, the encoder can select (1112) the filter whose shape and filter coefficients result in the lowest associated cost in the rate-distortion sense. The selected filter may be encoded (1113) into the bitstream, for example, within the video unit header. In some embodiments, the encoding (1113) performed by the encoder may involve various techniques, such as coefficient coding, which are described below.

Although not specifically described to this point, embodiments of the present invention may also be configured to apply different techniques to different color planes within video pictures (or other parts of a video picture that may have different statistics in the sample domain). A color plane can refer, for example, to the red, green, and blue color planes of an RGB video signal, or alternatively to the luminance (Y) and chrominance difference (Cr, Cb) planes of a YCrCb video signal, and the like. In some embodiments, encoders and/or decoders may be configured that are capable of optimizing the encoding for a certain color plane, while still allowing for prediction from, for example, one color plane to another. Further description of such optimization techniques may be found in U.S. Provisional Patent Application Ser. No. 61/499,088.

In some embodiments, it may be possible to reduce the overhead associated with encoding the coefficients of the selected filter set. For example, by taking advantage of video symmetry properties, such overhead may advantageously be reduced by approximately 50%.

Referring again to FIG. 6, an optimization that may be performed on the cross-shaped filter 601 (i.e., by the loop filter 103 in encoder 100 in FIG. 1) so as to reduce the number of filter coefficients used to define its shape will be described. In general, an N×N cross-shaped filter employs N+N−1 filter coefficients. For example, the 9×9 cross-shaped filter 601 employs 17 coefficients. A set of 16 different 9×9 cross-shaped filters therefore employs a total of 272 generally different coefficients (although, as will be seen, symmetry properties may effectively reduce this number). In the filter 601, the neighboring samples constituting the “cross” part are represented using horizontal/vertical (H/V) coordinates with respect to the center sample 621, which is located at some arbitrary position (x, y) within the video unit. For example, the location of sample 622 may be represented by (x-3, y) to reflect that the sample 622 is located three samples to the left of the centre sample 621. Likewise the location of sample 624 may be represented by (x, y-2) to reflect that the sample 624 is located two samples above the centre sample 621.

Samples that are related to one another symmetrically with respect to the position (x, y), according to one embodiment, are assigned the same filter coefficient. As used herein throughout, terms such as “symmetry” or “symmetrically related” may be used to refer to pairs of neighbouring samples within the video unit that are reflected 180 degrees about the centre sample 621 (informally that are located “opposite” to one another on either side of the center sample 621, whether horizontally, vertically or even diagonally opposite). Thus, in the filter 601, the samples 622 and 623 are reflected 180 degrees about (i.e., “opposite” relative to) the center sample 621 and, therefore, are assigned the same filter coefficient. Similarly, the samples 624 and 625 are related symmetrically relative to the center sample 621 and, therefore, are also assigned the same filter coefficient, although not necessarily the same as the filter coefficient assigned to the samples 622 and 623. Symmetry is also observable in the snowflake shaped filter 602 shown in FIG. 6.

By exploiting symmetry within a filter shape, the total number of coefficients used to define the filter shape may be reduced because a single coefficient may be assigned to a pair of symmetrically related samples that otherwise would have employed two coefficients. Thus, for every pair of symmetrically related samples within a filter shape, symmetry may allow one redundant coefficient to be eliminated from the filter specification. In the example of the filter 601, the number of the filter coefficients can be reduced from 17 to 9, resulting in savings of 8 coefficients (i.e., one coefficient for each of 8 pairs of symmetrically related samples). Accordingly, the number of coefficients required for a set of 16 different 9×9 cross-shaped filters may also be reduced from 272 to 144 different coefficients. The snowflake shaped filter 602 also comprises 8 pairs of symmetrically related samples and, therefore, requires the same number of coefficients as the cross-shaped filter 601.

In some embodiments, for every utilized filter shape, a set of filters can be generated during the encoding process using, for example, the techniques described in Marta Karczewicz et al., noted above.

In some embodiments, one or more filters in a selected filter set can be encoded, for example, using a three-stage process of quantization, prediction, and entropy coding as described in Y. Vatis, B. Edler, I. Wassermann, D. T. Nguyen, and J. Ostermann, “Coding of Coefficients of two-dimensional non-separable Adaptive Wiener Interpolation Filter”, Proc. VCIP 2005, SPIE Visual Communication & Image Processing, Beijing, China, July 2005, which is incorporated herein by reference in its entirety.

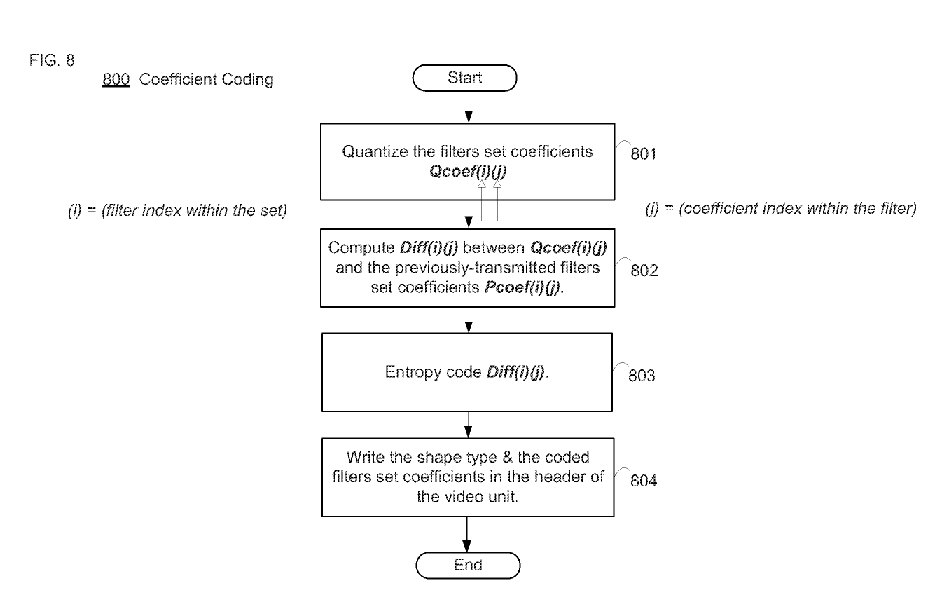

Referring now to FIG. 8, there is shown a flow diagram illustrating an example method 800 for coding the coefficients of each filter in a selected set of newly-generated filters, in accordance with an embodiment of the invention. The method 800 may be performed for each video unit within a video sequence and may utilize filter information relating to both the video unit presently being encoded, as well as filter information relating to one or more video units that have been previously encoded. Accordingly, relevant filter information may also be stored or otherwise communicated for later use within the method 800. The method 800 may be performed, for example, by the loop filter 103 in encoder 100 of FIG. 1

According to the method 800, the coefficients of each filter of the selected set are first quantized (801) using suitably chosen quantization factors. For example, different techniques for selecting quantization factors that provide acceptable compromise between filter accuracy and size of the side information may be used for this purpose. Then, the differences between the quantized coefficients and the coefficients (as available at the decoder, i.e., after quantization and de-quantization) of the previously-transmitted (corresponding) filters are computed (802). For this purpose, the coefficients of the previously transmitted filters may have been stored by the encoder. Then, the obtained difference values are entropy coded (803) and inserted (804) into the video unit header, parameter set, or other suitable place in the bitstream, as described earlier, in order to be made available to a decoder.

In many video compression standards, only bitstream syntax and decoder reaction to the bitstream are standardized, leaving many other aspects of video compression non-standardized and susceptible to modification and/or variation. For example, the selection of a particular filter shape according to any of the embodiments described herein may be implementation dependent and not part of a standard specification, whereas the syntax and semantics of the data structures or other information used in a bitstream (i.e., for transmission from encoder to decoder) to encode the shape and coefficients of the selected filter or filter set in accordance with the selected shape might be part of the standard specification.

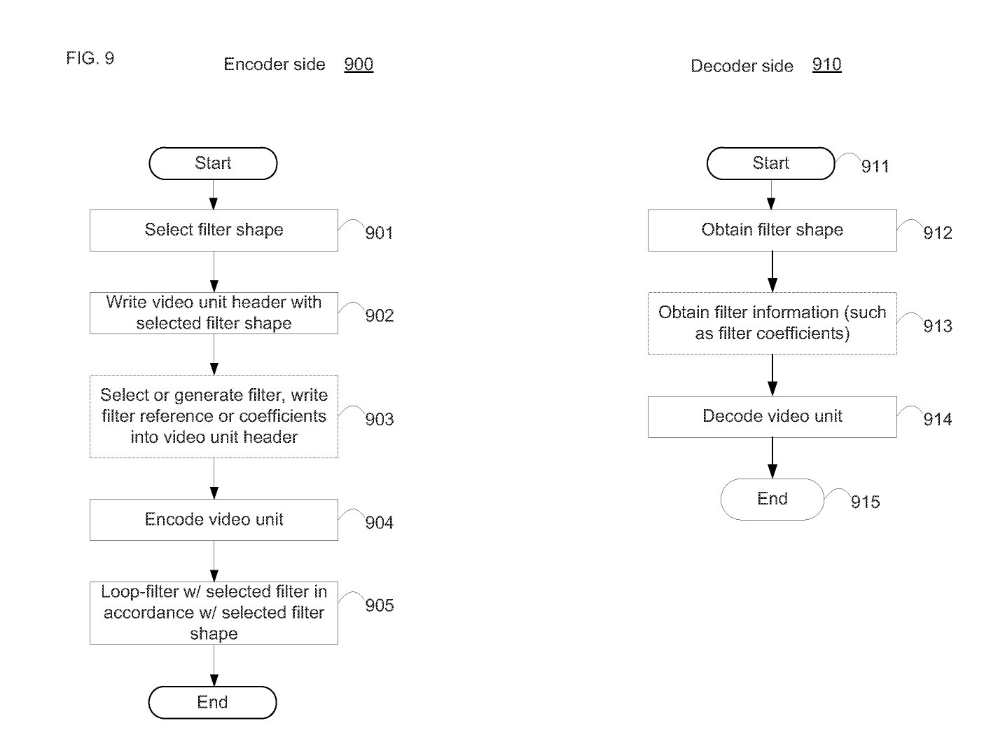

Referring now to FIG. 9, there are shown flow diagrams illustrating example methods for associated encoder-side and decoder-side operation, in accordance with an embodiment of the invention. More specifically, there is shown a method 900 for encoding a video unit and a method 910 for decoding a video unit. The method 900 may be performed, for example, by the encoder 100 of FIG. 1, while the method 910 may be performed by a decoder that has been configured, according to the described embodiments, for operation in association with the encoder 100. Accordingly, in some embodiments, the video unit decoded according to the method 910 may have been encoded according to the method 900.

On the encoder side, according to the method 900, a filter shape may be selected (901). In some embodiments, the selection (901) of a filter shape may be made manually (i.e., through a user interface in a video editing software). Alternatively, the selection (901) may be made automatically within the encoder, for example, as described above in the context of FIG. 7. In some embodiments, the selection (901) may be adaptive to the content of the coded video unit or, alternatively, independent of the content (i.e., selected based on general spatial characteristics of the video sequence).

If a newly generated shape is selected (901) by the encoder, which shape is not already available at the decoder, selection (901) of the filter shape may also involve the encoding of the shape. In some embodiments, the encoder may store records relating to the newly generated filter shapes that have been previously sent to the decoder. In this case, the encoder may access the stored records in deciding whether or not the newly generated filter shape is already available at the decoder. Thereafter, bit(s) or other data representing the selected filter shape are inserted (902) into the video unit header.

If only a single filter is defined for each filter shape, no further actions may be required by the encoder in relation to filter selection, except that the encoder may loop-filter the samples of the video unit after they have been coded using the available filters, and select the filter that yields the lowest Lagrangian cost (computed as described earlier). However, embodiments of the invention may advantageously incorporate further aspects of adaptive filter set selection as described in co-pending U.S. patent application Ser. No. 13/350,243. Where adaptive filter set selection is employed, further actions by the encoder may be taken, as described below.

In order to employ adaptive filter set selection, the encoder at this point may select (903), from a plurality of filter sets, a filter set of a given shape that minimizes the Lagrangian cost (computed as described earlier). Such selection may be made as described in United co-pending U.S. patent application Ser. No. 13/350,243. For example, the adaptive filter set selection may include determining whether a previously-used filter set is appropriate or else if a new filter set is to be utilized, and may further include writing a filter set reference or a set of newly-generated filters into the video unit header, parameter set, or other appropriate places in the bitstream, or alternatively conveying the information out of band. In some embodiments, incorporation of adaptive filter set selection into the method 900 is optional and is therefore indicated in FIG. 9 using dashed lines.

Then, the video unit is encoded (904). Such encoding may involve a motion search, motion vector coding, motion compensation of a reference block, calculating a residual, transform and quantize the residual, and creating a reference picture or parts therefore, depending on the size of the video unit. After the video unit has been encoded (904), the reconstructed samples are loop-filtered (905) using the selected (i.e., in 903) filter set containing filters of the same shape.

While the method 900 has been described in the above terms, certain variations and/or modifications may be possible within the context of the present disclosure. For example, rather than loop-filtering each video unit after encoding, in some embodiments, a number of video units within the same video picture may be encoded, and loop filtering may only be applied after the encoding of this number of the video units. In some cases, all video units of the video picture may be encoded prior to loop filtering. In some embodiments, it may also be possible to use different filter sets for different parts of a picture. In some cases, one or more of the different filters sets used may have a different shape from others.

On the decoder side, according to the method 910, a state machine or other data processor within a decoder that is configured to interpret the syntax and semantics of coded video sequences, at some point, determines (911) that receipt of data relating to, for example created by, an adaptive loop filter (e.g., loop filter 103 of encoder 101 in FIG. 1) is to be expected. This determination may be made through any suitable configuration of the state machine or data processor. The decoder obtains (912) shape information relating to the adaptive filter, for example, by reading the bit(s) within the video unit header in the bitstream that represent this shape information. For example, the filter shape information can be coded into the video unit header as a reference into a table of filter shapes or a coded form of the shape itself, for example, in the form of a bitmap, as describe above.

Optionally, where adaptive filter set selection has been incorporated into the encoding process (i.e., 903 in method 900), the decoder then obtains (913) additional information about the selected filter set from the video unit header. For example, this additional information can include a reference into a filter set table identifying a set of filters, or alternatively a set of coded filters. However, if no adaptive filter set selection was employed during coding, in which case only a single filter for each filter shape has been defined, then the decoder may decode the coefficients of the selected filter without obtaining any additional filter information.

Then, the decoder may decode (914) the video unit as usual with no further bitstream-related processing relating to filter selection. Such decoding can involve entropy decoding of the syntax elements of the video unit, inverse quantization and inverse transform of coded transform coefficients to re-create a residual, motion compensation, according to decoded motion vector(s), of reference picture samples from reference picture memory, and adding the motion compensated reference picture samples to the recreated residual. Finally, the decoded samples are loop filtered (915) using the obtained set of filters. Not shown, but also performed, is the storage of the loop filtered samples in the reference picture memory, from where they can be fetched during the decoding of future pictures.

In some embodiments, different sets of loop filters may be selected and used based on criteria and/or considerations other than video units. For example, different sets of filters may be used for the different color planes (e.g., as defined in YCrCb 4:2:0 uncompressed video). Accordingly, in some embodiments, more than one set of filters may be defined for each filter shape, with each such filter designed for a specific criterion other than spatial area, such as a color plane.

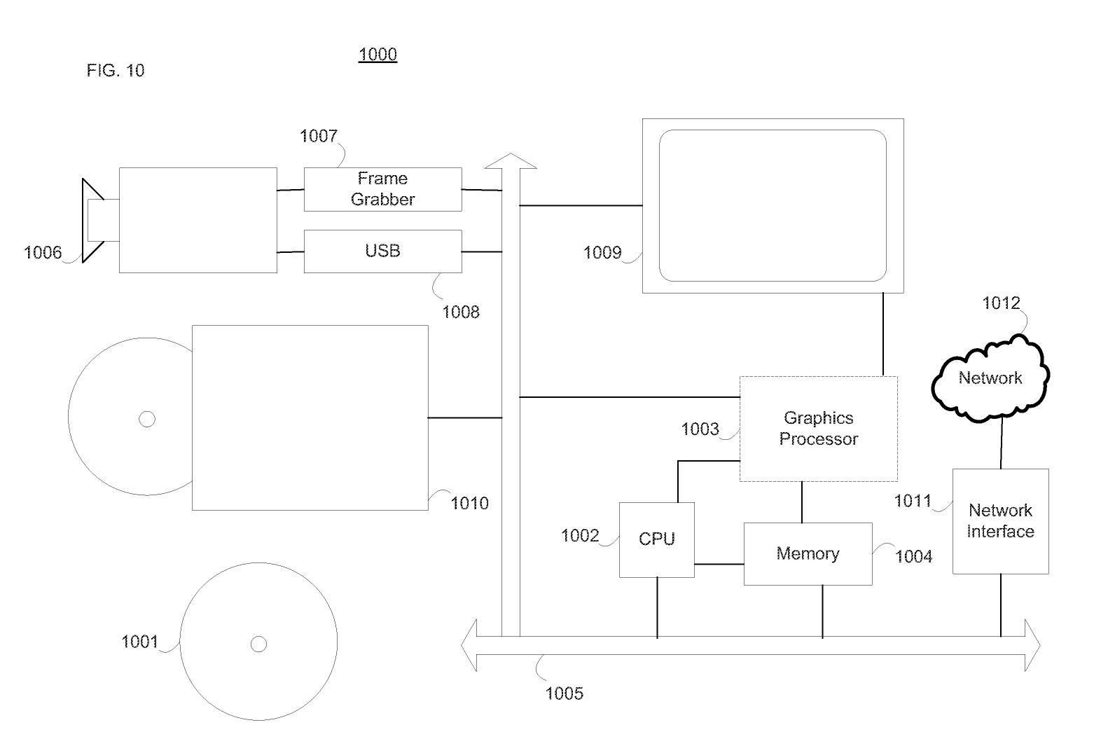

FIG. 10 shows a data processing system (e.g., a personal computer (“PC”)) 1000 based implementation in accordance with an embodiment of the invention. Up to this point, for convenience, the disclosure has not related explicitly to possible physical implementations of the encoder and/or decoder in detail. Many different physical implementations based on combinations of software and/or components are possible. For example, in some embodiments, the video encoder(s) and/or decoder(s) may be implemented using custom or gate array integrated circuits, in many cases, for reasons related to cost efficiency and/or power consumption efficiency.

Additionally, software implementations are possible using general purpose processing architectures, an example of which is the data processing systems 1000. For example, using a personal computer or similar device (e.g., set-top-box, laptop, mobile device), such an implementation strategy may be possible as described in the following. As shown in FIG. 10, according to the described embodiments, the encoder and/or the decoder for a PC or similar device 1000 may be provided in the form of a computer-readable media 1001 (e.g., CD-ROM, semiconductor-ROM, memory stick) containing instructions configured to enable a processor 1002, alone or in combination with accelerator hardware (e.g., graphics processor) 1003, in conjunction with memory 1004 coupled to the processor 1002 and/or the accelerator hardware 1003 to perform the encoding or decoding. The processor 1002, memory 1004, and accelerator hardware 1003 may be coupled to a bus 1005 that can be used to deliver the bitstream and the uncompressed video to/from the aforementioned devices. Depending on the application, peripherals for the input/output of the bitstream or the uncompressed video may be coupled to the bus 1005. For example, a camera 1006 may be attached through a suitable interface, such as a frame grabber 1007 or a USB link 1008, to the bus 1005 for real-time input of uncompressed video. A similar interface can be used for uncompressed video storage devices such as VTRs. Uncompressed video may be output through a display device such as a computer monitor or a TV screen 1009. A DVD RW drive, or equivalent (e.g., CD ROM, CD-RW Blue Ray, memory stick) 1010 may be used to input and/or output the bitstream. Finally, for real-time transmission over a network 1012, a network interface 1011 can be used to convey the bitstream and/or uncompressed video, depending on the capacity of the access link to the network 1012, and the network 1012 itself.

According to various embodiments, the above described method(s) may be implemented by a respective software module. According to other embodiments, the above described method(s) may be implemented by a respective hardware module. According to still other embodiments, the above described method(s) may be implemented by a combination of software and hardware modules.

While the embodiments have, for convenience, been described primarily with reference to an example method, the apparatus discussed above with reference to a data processing system 1000 may, according to the described embodiments, be programmed so as to enable the practice of the described method(s). Moreover, an article of manufacture for use with a data processing system 1000, such as a pre-recorded storage device or other similar computer readable medium or product including program instructions recorded thereon, may direct the data processing system 1000 so as to facilitate the practice of described method(s). It is understood that such apparatus and articles of manufacture, in addition to the described methods, all fall within the scope of the described embodiments.

In particular, the sequences of instruction which when executed cause the method described herein to be performed by the data processing system 1000 can be contained in a data carrier product according to one embodiment of the invention. This data carrier product can be loaded into and run buy the data processing system 1000. In addition, the sequences of instruction which when executed cause the method described herein to be performed by the data processing system 1000 can be contained in a computer program or software product according to one embodiment of the invention. This computer program or software product can be loaded into and run by the data processing system 600. Moreover, the sequences of instructions which when executed cause the method described herein to be performed by the data processing system 1000 can be contained in an integrated circuit product (e.g. hardware module or modules) which may include a coprocessor or memory according to one embodiment of the invention. This integrated circuit product can be installed in the data processing system 1000.

The embodiments of the invention described herein are intended to be exemplary only. Accordingly, various alterations and/or modifications of detail may be made to these embodiments, all of which come within the scope of the invention.

What is claimed is:

1. A method for video encoding, comprising:
in respect of at least one video unit, selecting a filter shape; and,
filtering at least one reconstructed video sample within the at least one video unit using a filter of the selected filter shape.

2. The method of claim 1, wherein the filter shape is selected from a plurality of different filter shapes.

3. The method of claim 2, wherein at least one filter shape in the plurality of different filter shapes is pre-defined.

4. The method of claim 3, wherein the at least one pre-defined filter shape comprises a cross shape.

5. The method of claim 4, wherein the cross shape is a 9×9 cross shape.

6. The method of claim 1, further comprising encoding filter specification information into a bitstream, the filter specification information including at least one of a maximum size of a filter shape, a maximum number of coefficient of a filter shape, or a maximum number of filter shapes.

7. The method of claim 1, further comprising one of inserting filter shape information into a bitstream or sending the filter shape information out of band, the filter shape information identifying the selected filter shape.

8. The method of claim 7, wherein the selected filter shape is a newly generated shape.

9. The method of claim 1, further comprising one of inserting coefficient information into a bitstream or sending the coefficient information out of band, the coefficient information representing at least one coefficient of a newly generated filter according to the selected filter shape.

10. A method for video decoding, comprising:
receiving information indicative of a filter shape selected from a plurality of different filter shapes; and,
filtering at least one reconstructed sample within a video unit using a filter of the shape indicated by the received information.

11. The method of claim 10, wherein at least one filter shape in the plurality of different filter shapes is predefined.

12. The method of claim 11, wherein the at least one predefined filter shape comprises a cross shape.

13. The method of claim 12, wherein the cross shape is a 9×9 cross shape.

14. The method of claim 10, further comprising decoding filter specification information from a bitstream or from information received out of band, the filter specification information including at least one of a maximum size of a filter shape, a maximum number of coefficient of a filter shape, or a maximum number of shapes.

15. The method of claim 10, further comprising decoding filter shape information from a bitstream or from information received out of band, the filter shape information identifying the selected filter shape.

16. The method of claim 15, wherein the selected filter shape is a newly generated shape.

17. The method of claim 10, further comprising decoding coefficient information from a bitstream or from information received out of band, the coefficient information representing at least one coefficient of a newly generated filter according to the selected filter shape.

18. A method of video encoding, comprising:
filtering at least one sample with a filter of a cross shape.

19. The method of claim 18, wherein the cross shape is an n×n cross shape, n being any integer greater than or equal to 3.

20. The method of claim 19, wherein n is equal to 9.

21. The method of claim 18, wherein the cross shape is a degenerated cross shape.

22. A method of video decoding, comprising:
filtering at least one sample with a filter of a cross shape.

23. The method of claim 22, wherein the cross shape is an n×n cross shape, n being any integer greater than or equal to 3.

24. The method of claim 23, wherein n is equal to 9.

25. The method of claim 22, wherein the cross shape is a degenerated cross shape.

26. A non-transitory computer readable media having computer executable instructions stored thereon for programming one or more processors to perform a method for video encoding, the method comprising:
in respect of at least one video unit, selecting a filter shape; and,
filtering at least one reconstructed video sample within the at least one video unit using a filter of the selected filter shape.

27. A non-transitory computer readable media having computer executable instructions stored thereon for programming one or more processors to perform a method for video decoding, the method comprising:
receiving information indicative of a filter shape selected from a plurality of different filter shapes; and,
filtering at least one reconstructed sample within a video unit using a filter of the shape indicated by the received information.

28. A non-transitory computer readable media having computer executable instructions stored thereon for programming one or more processors to perform a method for video encoding, the method comprising filtering at least one sample with a filter of a cross shape.

29. A non-transitory computer readable media having computer executable instructions stored thereon for programming one or more processors to perform a method for video decoding, the method comprising filtering at least one sample with a filter of a cross shape.
